(19) United States
(12) Patent Application Publication
(10) Pub. No.: US 2025/0024340 A1
(43) Pub. Date: Jan. 16, 2025

(54) MANAGING TRAFFIC FLOWS DURING A HANDOVER PROCEDURE

(71) Applicant: FG Innovation Company Limited, Tuen Mun (HK)

(72) Inventors: CHUN-YEN HSU, Taipei (TW); He-Hsuan Liu, Taipei (TW)

(21) Appl. No.: 18/770,010

(22) Filed: Jul. 11, 2024

Related U.S. Application Data
(60) Provisional application No. 63/526,281, filed on Jul. 12, 2023.

(51) Int. Cl. H04W 36/22; H04W 36/08

(52) U.S. Cl. CPC H04W 36/22; H04W 36/08

(57) ABSTRACT

A method performed by a source base station (e.g., a next generation node B (gNB)) for managing traffic flows during a handover procedure are provided. The method receives, from a core network (CN), first signaling including a value associated with a protocol data unit (PDU) set. The method prioritizes the PDU set based on the value. The method transmits, to a target gNB, second signaling including the value.

### CROSS-REFERENCE TO RELATED APPLICATION(S)

The present disclosure claims the benefit of and priority to U.S. Provisional Patent Application Ser. No. 63/526,281, filed on Jul. 12, 2023, entitled “HANDOVER WITH ESSENTIALITY,” the content of which is hereby incorporated herein fully by reference into the present disclosure for all purposes.

### FIELD

The present disclosure is related to wireless communication and, more specifically, to a method and a base station (e.g., a source next generation node B (gNB)) for managing traffic flows during a handover procedure in cellular wireless communication networks.

### BACKGROUND

Various efforts have been made to improve different aspects of wireless communication for the cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there is a need for further improvements in wireless communications in the next-generation wireless communication systems.

### SUMMARY

The present disclosure is related to a method and a source next generation node B (gNB) for managing traffic flows during a handover procedure in cellular wireless communication networks.

In a first aspect of the present application, a method performed by a source next generation node B (gNB) for managing traffic flows during a handover procedure is provided. The method includes receiving, from a core network (CN), first signaling including a value associated with a protocol data unit (PDU) set; prioritizing the PDU set based on the value; and transmitting, to a target gNB, second signaling including the value.

In an implementation of the first aspect, the second signaling includes a handover request message.

In another implementation of the first aspect, the value indicates a priority order of the PDU set.

In a second aspect of the present application, a source gNB for managing traffic flows during a handover procedure is provided. The source gNB includes at least one processor and at least one non-transitory computer-readable medium coupled to the at least one processor. The non-transitory computer-readable medium stores one or more computer-executable instructions that, when executed by the at least one processor, cause the source gNB to receive, from a core network (CN), first signaling including a value associated with a protocol data unit (PDU) set; prioritize the PDU set based on the value; and transmit, to a target gNB, second signaling including the value.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a schematic diagram illustrating a multi-modal interactive system, according to an example implementation of the present disclosure.

FIG. 2 is a flowchart illustrating a method/process performed by a source gNB for managing traffic flows during a handover procedure, according to an example implementation of the present disclosure.

FIG. 3 is a flowchart illustrating a method/process performed by a target gNB for managing traffic flows during a handover procedure, according to an example implementation of the present disclosure.

FIG. 4 is a block diagram illustrating a node for wireless communication, according to an example implementation of the present disclosure.

### DESCRIPTION

Some of the abbreviations used in this disclosure include:
Abbreviation Full name
3GPP 3^{rd} Generation Partnership Project
5G 5^{th} Generation
AMF Access and Mobility Management Function
BWP Bandwidth Part
DCI Downlink Control Information
DL Downlink
gNB Next Generation Node B
HO Handover
IE Information Element
LCH Logical Channel
LCID Logical Channel ID
LTE Long Term Evolution
MAC Medium Access Control
MCS Modulation and Coding Scheme
MIB Master Information Block
NR New Radio
NTN Non-Terrestrial Network
NW Network
PDCCH Physical Downlink Control Channel
PDSCH Physical Downlink Shared Channel
PDU Protocol Data Unit
PHY Physical (layer)
PRACH Physical Random Access Channel
PSS Primary Synchronization Signal
PUCCH Physical Uplink Control Channel
PUSCH Physical Uplink Shared Channel
QoS Quality of Service
RRC Radio Resource Control
SDU Service Data Unit
SIB System Information Block
TN Terrestrial Network
UE User Equipment
UL Uplink
XR Extended Reality

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As described above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency (e.g., “based on”, “more specifically”, “preferably”, “in one embodiment”, “in some implementations”, etc.) in the present disclosure may be only one possible example and shall not restrict the specific method.

“A and/or B,” in the present disclosure, may include either A or B, both A and B, or at least one of A and B.

The terms “multi-modal” and “multi-modality” may be used interchangeably in the present disclosure.

The multi-modal data may include the input data received from different kinds of devices/sensors or the output data transmitted to different kinds of destinations (e.g., one or more UEs) that are required for performing the same task or application. The multi-modal data may include more than one type of single-modal data, and there may be strong dependencies among each type of the single-modal data. The single-modal data may be defined as one type of data.

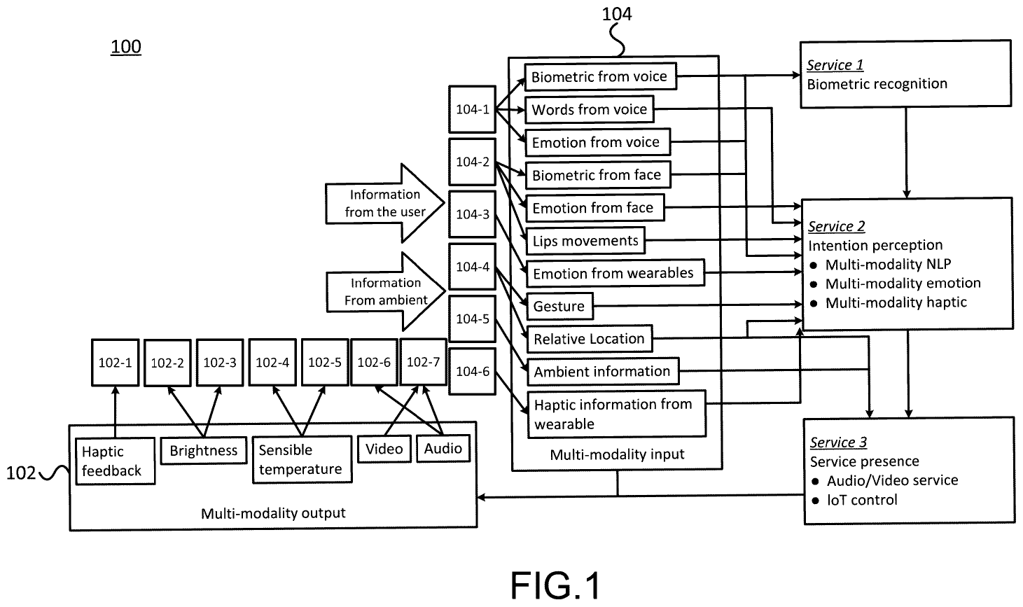

FIG. 1 is a schematic diagram illustrating a multi-modal interactive system 100, according to an example implementation of the present disclosure. As shown in FIG. 1, the multi-modal outputs 102 (e.g., the haptic feedback, brightness, sensible temperature, video and/or audio, etc.) may be generated based on the multi-modal inputs 104 received from multiple sources 104-1, 104-2, 104-3, 104-4, 104-5, and 104-6. The multi-modal outputs 102 may be output to multiple destinations 102-1, 102-2, 102-3, 102-4, 102-5, 102-6, and 102-7. The multiple sources 104-1, 104-2, 104-3, 104-4, 104-5, and 104-6 may include, but are not limited to, microphones, cameras, monitors, smartwatches, smart wristbands, robot vacuums, etc. The multiple destinations 102-1, 102-2, 102-3, 102-4, 102-5, 102-6, and 102-7 may include, but are not limited to, speakers, headphones, display devices, projectors, temperature control devices, lighting control systems, wearable devices with vibration, haptic gloves, etc.

In the multi-modal interactive system 100, a modality may include a type or representation of information in a specific interactive system. The multi-modal interaction may include the process during which information of multiple modalities are exchanged. The modal types may include, but are not limited to, motions, sentiments, gestures, etc. The modal representations may include, but are not limited to, videos, audios, tactition (e.g., vibrations or other movements which provide haptic or tactile feelings to a person), etc.

The tactile and multi-modal communication services may enable the multi-modal interactions, combining ultra-low latency with extremely high availability, reliability, and security. The tactile internet may be applied in multiple fields, including industry, robotics and telepresence, virtual reality, augmented reality, healthcare, road traffic, serious gaming, education and culture, smart grids, etc. The multiple modalities may be used in combination within a service to provide complementary methods that may not only convey redundant information but may also convey information more effectively. By combining input received from more than one source and/or output to more than one destination, the interpretation in communication services will be more accurate and faster, responses may also be quicker, and the communication service may be smoother and more natural.

For a typical tactile and multi-modal communication service/application, there may be different modalities affecting the user experience, such as:
(i) video/audio media,
(ii) information perceived by sensors about the environment (e.g., brightness, temperature, and humidity, etc.), and
(iii) haptic data which may include feelings when touching a surface (e.g., pressure, texture, vibration, temperature, etc.), or kinesthetic senses (e.g., gravity, pull forces, sense of position awareness, etc.).

The ambient information may be further processed to generate IoT control instructions, as feedback(s). The haptic data, based on physiological perception, may have specific characteristics (e.g., frequency and latency), and may require an adequate periodic, deterministic, and reliable communication path. For example, the sampling rate of a haptic device for teleoperation systems may reach 1000 times per second, and samples may be typically transmitted individually, resulting in 1000 packets per second, whereas the video may be transmitted at 60/90 frames per second. The high-frequency transmission of small packets over a long distance may pose a significant challenge for the 5G systems.

The multiple modalities may be transmitted simultaneously to multiple application servers for further processing in a coordinated manner, including QoS coordination, traffic synchronization, power saving, etc.

The multiple outcomes may be generated, as the feedback(s). In the scenario of a real-time remote virtual reality service, a VR user may use multiple independent devices to separately collect video, audio, ambient, and haptic data from the user and may receive video, audio, ambient, and haptic feedback from one or multiple application servers for the same VR application. In this case, an end user may wear VR glasses to receive images and sounds, a touch glove to receive touch sensations, a camera to collect video inputs, a microphone to collect audio inputs, and multiple wearable sensors to provide haptic information and environmental information associated with the user. The real-time remote virtual reality service may also be conducted between two users.

The multiple outcomes may need to reach the distributed UEs at the same time. In the scenario of a sound field reappearance, different channels of sound may be sent to the distributed sound boxes to simulate sound coming from a particular direction. A small time difference may cause a significant direction error that may impact the user experience. In some cases, a time difference of 1 ms may cause more than a 30° angle of error.

The multi-modal applications may involve a large number of UEs located within a long distance. In the scenario of multi-modal telepresence, tens of UEs may need synchronization for time, control signals, and visual signals.

In another scenario, the devices associated with the same tactile and multi-modal communication service may be triggered to wake up by the discovery of a tactile and multi-modality capable user/UE in a proximity. A different group of tactile and multi-modality capable devices may serve the user as the use changes location.

Other scenarios that may be investigated may include industrial manufacturing and real-time drone applications, which may require a synchronous control of a visual-haptic feedback.

The 3GPP aims to support coordinated transmissions for multi-modality flows with a single UE. Some advanced XR or media services may include multiple types of flows (e.g. video/audio streams, and haptic or sensor data for a more immersive experience).

The application client(s) for the different types of data of one application may be stored at a UE. In another case, there may be multiple types of devices (e.g., VR glasses, gloves, and other devices that support haptic and/or kinesthetic modalities), and these devices may be connected (e.g., through wirelines) to a single UE that may access the 5GS.

The 3GPP is discussing how to enhance the 5GS to better support the coordinated delivery of application traffic streams that are related to each other. The targets may include:
(i) Delivering related tactile and multi-modal data (e.g., audio, video, and haptic data related to a specific time) for an application to the user at a similar time (e.g., QoS policy coordination); and
(ii) Ensuring application synchronization and QoS policy coordination between multiple QoS flows.

Furthermore, the support of mobile extended reality (XR) has been agreed upon by service and system aspects (SA) in, for example, SA #99. The goal of the work is to specify that the 5G system shall support service continuity for the XR services and support connectivity for the XR services under a high UE mobility. Challenges may be raised for supporting seamless access to an XR application through the 5GS during the UE mobility. Considering the mobility pattern of outdoor scenarios for, for example, vehicles and trains, the support for connectivity of the XR services may be required when the UE moves at speeds of up to 120 km/h (e.g., vehicles) and 500 km/h (e.g., trains).

To simplify the above scenarios' description, without loss of generality, only a one-slice scenario may be considered in the present disclosure. The concept, descriptions, and operations described in this disclosure, however, may be easily extended to multi-slice scenarios.

Each upper layer packet stream may be mapped to a traffic flow established between the UE and the network (NW). Each traffic flow may have a QoS profile. When a UE needs to perform a handover (HO) procedure to maintain the service continuity, a source gNB may select a first target gNB among all candidate gNBs and may initiate the handover preparation procedure by sending a handover request (HANDOVER_REQ) message to the first target gNB. In the current 3GPP handover procedure design, if all traffic flows are admitted by the target gNB, the target gNB may send a handover acknowledgment (HANDOVER_ACK) message to the source gNB.

In some implementations, such an admission may be performed per slice. If the first target gNB does not admit all the traffic flows, the first target gNB may send a HANDOVER PREPARATION FAILURE message to the source gNB. After receiving the HANDOVER PREPARATION FAILURE message from the first target gNB, the source gNB may need to select a second target gNB for the UE and may initiate a new handover preparation procedure by sending a HANDOVER_REQ message to the second target gNB. This process may continue until the source gNB finds a target gNB that may admit all the traffic flows of the UE, or no candidate gNB may be found that admits all the traffic flows of the UE. This whole process may take time and degrade the user experience in the following two aspects (i) and (ii):
(i) In general, the first target gNB may be the optimal one among all candidate gNBs in terms of the radio signal strength. Handover to a sub-optimal target gNB may potentially result in a performance degradation.
(ii) When the source gNB continuously tries to find a gNB that admits all the traffic flows of the UE, the UE's wireless channel condition may continuously degrade. This may increase the probability of a handover failure or a radio link failure. The channel condition degradation may be very fast and severe in the high mobility scenarios.

In some implementations, to address the issues described above, a handover with an essentiality scheme may be introduced. Traffic flows may be classified based on their essentiality to the user experience. The NW may ensure that all essential traffic flows are maintained during the handover, while non-essential traffic flows may be maintained as much as possible. A target gNB may accept a handover request from a source gNB if all essential traffic flows are admitted.

In the following, a basic mechanism for addressing the above-described issues is provided.

gNB_step_A1: A Boolean-type essentiality attribute may be used by the NW to indicate to the gNB whether a traffic flow is essential. An essential traffic flow may be a traffic flow with the essentiality attribute set to “TRUE.” A non-essential traffic flow may be a traffic flow that is not essential. The NW may indicate the essentiality attribute of a traffic flow during a traffic flow establishment procedure.

gNB_step_A2: When a source gNB decides to handover a UE's traffic flows to a target gNB, the source gNB may send a HANDOVER_REQ message that includes traffic flow information (e.g., including the essentiality attribute) to the target gNB.

gNB_step_A3: After the target gNB receives the HANDOVER_REQ message from the source gNB, if the target gNB admits all the essential traffic flows, the target gNB may send a HANDOVER_ACK message to the source gNB. The HANDOVER_ACK message may include a PDU Session Resources Admitted List that indicates the admitted traffic flows. The HANDOVER_ACK message may further include a PDU Session Resources Not Admitted List that indicates the traffic flows that are not admitted by the target gNB.

gNB_step_A4: If the source gNB receives the HANDOVER_ACK message including the PDU Session Resources Not Admitted List, the source gNB may send a HANDOVER_CMD message to the UE. The source gNB may indicate the traffic flows that are not admitted by the target gNB by including the PDU Session Resources Not Admitted List in the HANDOVER_CMD message.

UE_step_A1: If the UE receives the HANDOVER_CMD message including the PDU Session Resources Not Admitted List, the UE may release the traffic flows indicated by the PDU Session Resources Not Admitted List.

In the following, an alternative procedure/mechanism is provided.

gNB_step_B1: An essentiality value may be used for the NW to indicate the essentiality of a traffic flow to a gNB. An essential traffic flow may include a traffic flow with an essentiality value higher than a threshold thres_ess. The NW may indicate the essentiality value of the traffic flow during a traffic flow establishment procedure.

gNB_step_B2: When a source gNB decides to handover a UE's connection to a target gNB, the source gNB may send a HANDOVER_REQ message that includes the UE's traffic flow essentiality and the threshold thres_ess to the target gNB.

gNB_step_B3: After the target gNB receives the HANDOVER_REQ message from the source gNB, if the target gNB admits all the traffic flows the essentiality of which are above the threshold thres_ess, the target gNB may send a HANDOVER_ACK message to the source gNB. The HANDOVER_ACK message may include a PDU Session Resources Admitted List that indicates the admitted traffic flows. The HANDOVER_ACK message may further include a PDU Session Resources Not Admitted List that indicates the traffic flows that are not admitted by the target gNB.

gNB_step_B4: If the source gNB receives the HANDOVER_ACK message including the PDU Session Resources Not Admitted List, the source gNB may send a HANDOVER_CMD message to the UE. The source gNB may indicate the traffic flows that are not admitted by the target gNB by including the PDU Session Resources Not Admitted List in the HANDOVER_CMD message.

UE_step_B1: If a UE receives the HANDOVER_CMD message including the PDU Session Resources Not Admitted List, the UE may release the traffic flows indicated by the PDU Session Resources Not Admitted List.

The HANDOVER_REQ message may include a HANDOVER REQUEST message, as specified, for example, in the 3GPP TS 38.423. The HANDOVER_ACK message may include a HANDOVER REQUEST ACKNOWLEDGE message. The HANDOVER_CMD message may include an RRC reconfiguration (RRCReconfiguration) message. The PDU Session Resources Not Admitted List included in the HANDOVER_CMD message may include a particular IE, such as a to-release list (ToReleaseList) IE.

The essentiality of the traffic flow may be implied from (or indicated by) the traffic flow's identifier. Specifically, the essentiality of the traffic flow may be implied from the QoS Flow Identifier (QFI) of the traffic flow. In some implementations, the essentiality of the traffic flow may be implied from (or indicated by) the 5G QoS Identifier (5QI) of the traffic flow. The threshold thres_ess may be pre-configured to the gNB by the core network or by an operator. If the threshold thres_ess has been pre-configured to the gNB, the threshold thres_ess may be omitted in the HANDOVER_REQ message.

A target gNB may omit the traffic flow information of the admitted essential traffic flows and the traffic flow information of not admitted non-essential traffic flows in the HANDOVER ACK message. In some implementations, the target gNB may send a HANDOVER_ACK message including a PDU Session Resources Admitted List that indicates only the admitted non-essential traffic flows. Upon receiving the HANDOVER_ACK from a target gNB, the source gNB may determine that all essential traffic flows were admitted by the target gNB and all non-essential traffic flows that are not indicated by the PDU Session Resources Admitted List were not admitted by the target gNB.

The UE may provide the essentiality value of its traffic flow to the NW. The message used by the UE to carry the essentiality value may include a PDU SESSION ESTABLISHMENT REQUEST message, a PDU SESSION MODIFICATION REQUEST message, or a SERVICE REQUEST message.

If the UE receives a HANDOVER_CMD message including a PDU Session Resources Not Admitted List, the UE may re-associate the upper layer packet streams previously associated with the traffic flows indicated by the PDU Session Resources Not Admitted List to one or more traffic flows that are not indicated by the PDU Session Resources Not Admitted List.

If the UE determines to re-associate the upper layer packet streams previously associated with the traffic flows indicated by the PDU Session Resources Not Admitted List to one or more traffic flows that are not indicated by the PDU Session Resources Not Admitted List, the UE may send a request message to the NW indicating the requested traffic flow re-association. The message used by the UE to carry the requested traffic flow re-association may include a PDU SESSION MODIFICATION REQUEST message.

A UE may indicate its capability for supporting the release portion of the traffic flows during the handover to the network. The message used to indicate the UE capability may include a UE capability information (UECapabilityInformation) message or a UE assistance message (UEassistanceMessage).

In some implementations, to address the issues described in the present disclosure, a divided handover scheme may be introduced. In the divided handover scheme, a source gNB may handover the UE's traffic flows to multiple target gNBs. The source gNB may indicate the divided handover to the target gNBs. Each target gNB may admit only a part of the traffic flows requested by the source gNB. Each target gNB may indicate the traffic flows that have been admitted or not admitted to the source gNB.

In the following, a basic procedure/mechanism for the above-described scheme is provided.

gNB_step_C1: A DIVIDED_HANDOVER indication may be included in a HANDOVER_REQ message. A source gNB may set the DIVIDED_HANDOVER indication to indicate, to a target gNB, that the HANDOVER_REQ message is a handover request for a divided handover procedure.

gNB_step_C2: When the source gNB decides to handover all or part of the UE's traffic flows to a first target gNB using the divided handover procedure, the source gNB may send the HANDOVER_REQ message (e.g., a first HANDOVER_REQ message), with the DIVIDED_HANDOVER indication set, as well as the traffic flow information, to the first target gNB.

gNB_step_C3: After the first target gNB receives the HANDOVER_REQ message (e.g., the first HANDOVER_REQ message), with the DIVIDED_HANDOVER indication set, from the source gNB, if the first target gNB admits only a part of the traffic flows, the first target gNB may send a HANDOVER ACK message to the source gNB. The HANDOVER_ACK message may include a PDU Session Resources Admitted List that indicates the admitted traffic flows. The HANDOVER_ACK message may further include a PDU Session Resources Not Admitted List that indicates the traffic flows that are not admitted by the first target gNB.

gNB_step_C4: If the source gNB receives the HANDOVER_ACK message including the PDU Session Resources Not Admitted List, the source gNB may decide to handover all or part of the traffic flows indicated by the PDU Session Resources Not Admitted List to a second target gNB by sending a HANDOVER_REQ message (e.g., a second HANDOVER_REQ message), including the corresponding traffic flow information, to the second target gNB.

gNB_step_C5: The source gNB may send a HANDOVER_CMD message to the UE. The source gNB may indicate the respective target gNB of each traffic flow in the HANDOVER_CMD message if the traffic flows are to be handed over to more than one gNB. The source gNB may further indicate the traffic flows not admitted by any of the target gNBs by including the PDU Session Resources Not Admitted List in the HANDOVER_CMD message.

UE_step_C1: If the UE receives the HANDOVER_CMD message including the PDU Session Resources Not Admitted List, the UE may release the traffic flows indicated by the PDU Session Resources Not Admitted List.

UE_step_C2: If the UE receives the HANDOVER_CMD message including information of multiple target gNBs, the UE may perform a handover execution procedure with each of the target gNBs.

In the following, an alternative procedure/mechanism is provided.

gNB_step_D1: A DIVIDED_HANDOVER indication may be included in a HANDOVER_REQ message (e.g., a first HANDOVER_REQ message). A source gNB may set the DIVIDED_HANDOVER indication to indicate to a target gNB that the HANDOVER_REQ message is a handover request for a divided handover procedure.

gNB_step_D2: When the source gNB decides to handover the UE's traffic flows to multiple target gNBs using the divided handover procedure, the source gNB may send a HANDOVER_REQ message including the corresponding traffic flow information to each of the target gNBs.

gNB_step_D3: After a first target gNB receives the HANDOVER_REQ message (e.g., a first HANDOVER_REQ message), with the DIVIDED_HANDOVER indication set, from the source gNB, if the first target gNB admits only a part of the traffic flows, the first target gNB may send a HANDOVER_ACK message to the source gNB. The HANDOVER_ACK message may include a PDU Session Resources Admitted List that indicates the admitted traffic flows. The HANDOVER_ACK message may further include a PDU Session Resources Not Admitted List that indicates the traffic flows that are not admitted by the first target gNB.

gNB_step_D4: If the source gNB receives the HANDOVER_ACK message including the PDU Session Resources Not Admitted List, the source gNB may decide to handover all or part of the traffic flows indicated by the PDU Session Resources Not Admitted List to a second target gNB by sending a HANDOVER_REQ message (e.g., a second HANDOVER_REQ message) including the corresponding traffic flow information to the second target gNB.

gNB_step_D5: The source gNB may send a HANDOVER_CMD message to the UE. The source gNB may indicate the respective target gNB of each traffic flow in the HANDOVER_CMD message if the traffic flows are to be handed over to more than one gNB. The source gNB may further indicate the traffic flows that are not admitted by any target gNBs by including the PDU Session Resources Not Admitted List in the HANDOVER_CMD message.

UE_step_D1: If the UE receives the HANDOVER_CMD message including the PDU Session Resources Not Admitted List, the UE may release the traffic flows indicated by the PDU Session Resources Not Admitted List.

UE_step_D2: If the UE receives the HANDOVER_CMD message including information of multiple target gNBs, the UE may perform a handover execution procedure with each of the target gNBs.

The HANDOVER_REQ message may include a HANDOVER REQUEST message, as specified, for example, in the 3GPP TS 38.423. The HANDOVER_ACK message may include HANDOVER a REQUEST ACKNOWLEDGE message. The HANDOVER_CMD message may include an RRCReconfiguration message. The PDU Session Resources Not Admitted List included in the HANDOVER_CMD message may include a particular IE, such as the ToReleaseList IE.

A DIVIDED_HANDOVER_REQ message may be used for a source gNB to request for performing a divided handover procedure with a target gNB. The DIVIDED HANDOVER_REQ message may include the information of the traffic flows that are requested to be handed over to the target gNB. In some implementations, the DIVIDED HANDOVER_REQ message may be the same as a HANDOVER_REQ message with a DIVIDED_HANDOVER indication set.

A first target gNB may omit the traffic flow information of admitted traffic flows indicated in the HANDOVER_ACK message. In some implementations, the HANDOVER ACK message may include the PDU Session Resources Admitted List and not include the PDU Session Resources Not Admitted List. Upon receiving the HANDOVER ACK from the target gNB, the source gNB may determine that all the traffic flows indicated by the PDU Session Resources Admitted List were admitted by the target gNB, whereas all the other traffic flows were not admitted by the target gNB. The source gNB may select a second target gNB. The source gNB may decide to handover all or part of the traffic flows that are not indicated by the PDU Session Resources Admitted List to the second target gNB. The source gNB may send the HANDOVER_REQ message including the corresponding traffic flow information to the second target gNB.

The corresponding traffic flow information may include at least one of the following parameters (i)-(v).
(i) flow ID,
(ii) quality of service requirement of the traffic flow,
(iii) traffic direction (e.g., uplink, downlink, or both),
(iv) aggregated quality of service requirement of the UE, and
(v) any other parameter that is required by the target gNB to manage the traffic flow.

A UE may indicate its capability of its support for handover traffic flows to more than one target gNB. The UE may indicate the supported maximum number of target gNBs. The UE may indicate the supported target gNB types (e.g., TN/NTN/LTE). The message used to indicate the capability may include a UECapabilityInformation message.

In some implementations, a source gNB may decide to handover part of the UE's traffic flows to the target gNB(s). The source gNB may indicate the traffic flows to be handed over to the target gNB.

In the following, a basic procedure/mechanism for implementing the above-discussions is provided.

gNB_step_E1: When a source gNB decides to handover part of the traffic flows of a UE to a target gNB, the source gNB may send a HANDOVER_REQ message including the traffic flow information of the traffic flows to be handed over to the target gNB.

gNB_step_E2: After the target gNB receives the HANDOVER_REQ message, if the target gNB admits the traffic flows indicated in the HANDOVER_REQ message, the target gNB may send a HANDOVER_ACK message to the source gNB.

gNB_step_E3: After the source gNB receives the HANDOVER_ACK message from the target gNB, the source gNB may send a HANDOVER_CMD message including the list of the traffic flows to be handed over to the target gNB.

UE_step_E1: After the UE receives the HANDOVER_CMD message including the list of the traffic flows to be handed over to the target gNB, the UE may perform a random access procedure with the target gNB to continue the traffic flows indicated in the HANDOVER_CMD message.

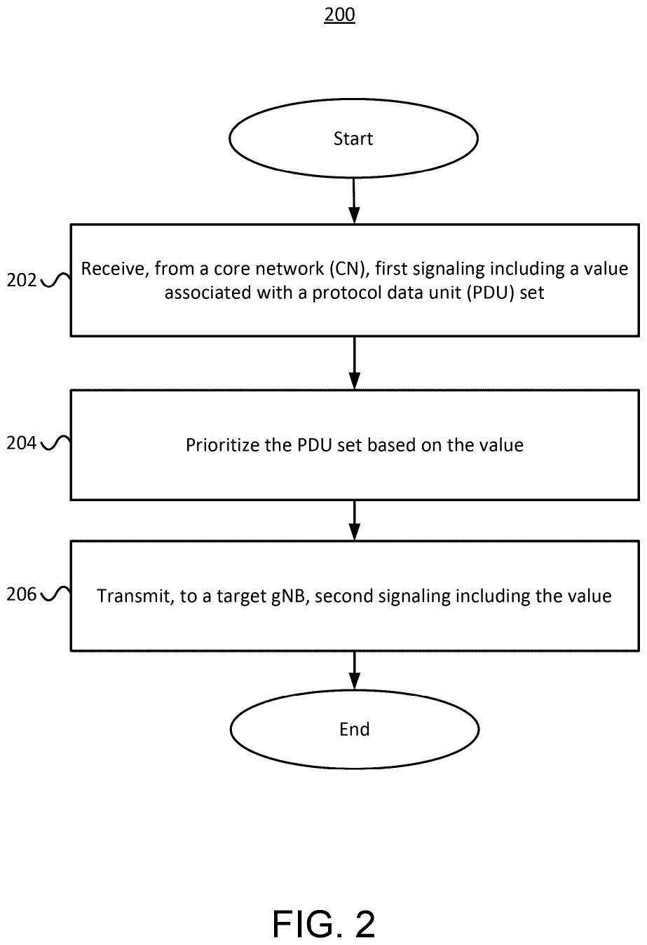

FIG. 2 is a flowchart illustrating a method/process 200 performed by a source next generation node B (gNB) for managing traffic flows during a handover procedure, according to an example implementation of the present disclosure.

Process 200 may start, in action 202, by the source gNB receiving, from a network (e.g., a core network (CN)), first signaling including a value associated with a protocol data unit (PDU) set. In some implementations, the value may indicate a priority order of the PDU set.

In action 204, the source gNB may prioritize the PDU set based on the value after receiving the first signaling.

In action 206, the source gNB may transmit, to a target gNB, second signaling including the value. In some implementations, the second signaling may include a handover request message.

The technical problem addressed by the present disclosure is how to maintain service quality and continuity (e.g., of the transmission/reception of the data flows) by effectively communicating the priority information of the protocol data unit (PDU) set to the target gNB. This communication is critical for the target gNB to appropriately manage and handle the incoming/outgoing traffic flows, thereby minimizing disruptions and maintaining the quality of service during the handover.

By transmitting second signaling that includes the value associated with the PDU set to the target gNB, the method provided in the present disclosure ensures that the target gNB receives the necessary priority information to manage the traffic flows effectively. This results in improved coordination between the source and target gNBs, reducing the likelihood of packet loss and latency. Consequently, the handover process becomes smoother and more reliable, enhancing the overall user experience by maintaining consistent service quality. The method provided in the present disclosure also facilitates better resource management at the target gNB, allowing it to prioritize critical traffic flows and allocate resources more efficiently.

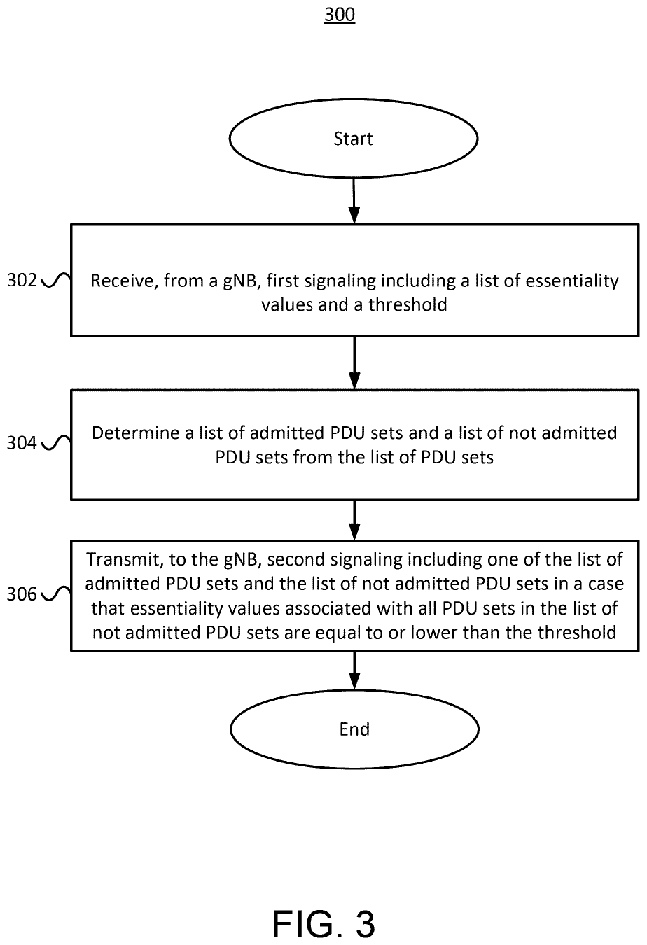

FIG. 3 is a flowchart illustrating a method/process 300 performed by a target next generation node B (gNB) for managing traffic flows during a handover procedure, according to an example implementation of the present disclosure.

Process 300 may start, in action 302, by the target gNB receiving, from a gNB (e.g., a source gNB), first signaling (e.g., first Xn application protocol (XnAP) signaling) including a list of essentiality values and a threshold. The list of essentiality values and the threshold may be associated with a list of PDU sets. Each essentiality value of the list of essentiality values may be associated with each PDU set of the list of PDU sets.

In action 304, the target gNB may determine a list of admitted PDU sets and a list of not admitted PDU sets from the list of PDU sets. The essentiality value associated with each PDU set in the list of admitted PDU sets may be higher than, equal to, or lower than the threshold. The essentiality value associated with each PDU set in the list of not admitted PDU sets may be higher than, equal to, or lower than the threshold.

In action 306, the target gNB may transmit, to the gNB, second signaling (e.g., second XnAP signaling) including one of the list of admitted PDU sets and the list of not admitted PDU sets in a case that essentiality values associated with all PDU sets in the list of not admitted PDU sets are equal to or lower than the threshold. In some implementations, the target gNB may not transmit, to the gNB, the second signaling including one of the list of admitted PDU sets and the list of not admitted PDU sets in a case that an essentiality value associated with at least one PDU set in the list of not admitted PDU sets is higher than the threshold.

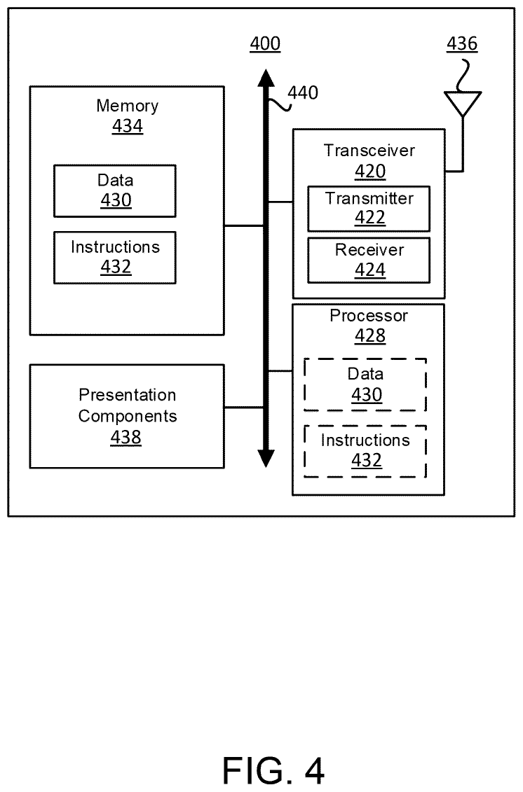

FIG. 4 is a block diagram illustrating a node 400 for wireless communication in accordance with various aspects of the present disclosure. As illustrated in FIG. 4, a node 400 may include a transceiver 420, a processor 428, a memory 434, one or more presentation components 438, and at least one antenna 436. The node 400 may also include a radio frequency (RF) spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. The node 400 may be a UE or a BS that performs various functions disclosed with reference to FIGS. 1 to 3.

The transceiver 420 has a transmitter 422 (e.g., transmitting/transmission circuitry) and a receiver 424 (e.g., receiving/reception circuitry) and may be configured to transmit and/or receive time and/or frequency resource partitioning information. The transceiver 420 may be configured to transmit in different types of subframes and slots including, but not limited to, usable, non-usable, and flexibly usable subframes and slot formats. The transceiver 420 may be configured to receive data and control channels.

The node 400 may include a variety of computer-readable media. Computer-readable media may be any available media that may be accessed by the node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above-listed components should also be included within the scope of computer-readable media.

The memory 434 may include computer-storage media in the form of volatile and/or non-volatile memory. The memory 434 may be removable, non-removable, or a combination thereof. Example memory may include solid-state memory, hard drives, optical-disc drives, etc. As illustrated in FIG. 4, the memory 434 may store a computer-readable and/or computer-executable instructions 432 (e.g., software codes) that are configured to, when executed, cause the processor 428 to perform various functions disclosed herein, for example, with reference to FIGS. 1 to 3. Alternatively, the instructions 432 may not be directly executable by the processor 428 but may be configured to cause the node 400 (e.g., when compiled and executed) to perform various functions disclosed herein.

The processor 428 (e.g., having processing circuitry) may include an intelligent hardware device, e.g., a Central Processing Unit (CPU), a microcontroller, an ASIC, etc. The processor 428 may include memory. The processor 428 may process the data 430 and the instructions 432 received from the memory 434, and information transmitted and received via the transceiver 420, the baseband communications module, and/or the network communications module. The processor 428 may also process information to send to the transceiver 420 for transmission via the antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a source next generation node B (gNB) for managing traffic flows during a handover procedure, the method comprising:
receiving, from a core network (CN), first signaling comprising a value associated with a protocol data unit (PDU) set;
prioritizing the PDU set based on the value; and
transmitting, to a target gNB, second signaling comprising the value.

2. The method of claim 1, wherein the second signaling comprises a handover request message.

3. The method of claim 1, wherein the value indicates a priority order of the PDU set.

4. A source next generation node B (gNB) for managing traffic flows during a handover procedure, the source gNB comprising:
at least one processor; and
at least one non-transitory computer-readable medium coupled to the at least one processor, and storing one or more computer-executable instructions that, when executed by the at least one processor, cause the source gNB to:
receive, from a core network (CN), first signaling comprising a value associated with a protocol data unit (PDU) set;
prioritize the PDU set based on the value; and
transmit, to a target gNB, second signaling comprising the value.

5. The source gNB of claim 4, wherein the second signaling comprises a handover request message.

6. The source gNB of claim 4, wherein the value indicates a priority order of the PDU set.
